(19) United States
(12) Patent Application Publication
(10) Pub. No.: US 2018/0025165 A1
(43) Pub. Date: Jan. 25, 2018

(54) METHOD OF CONTROLLING MOBILE HARD DRIVE VIA MOBILE DEVICE

(71) Applicant: SHENZHEN KSY CO., LTD., Shenzhen, Guangdong (CN)

(72) Inventors: Liang GAO, Shenzhen, Guangdong (CN); Cuie HUANG, Shenzhen, Guangdong (CN)

(73) Assignee: SHENZHEN KSY CO., LTD., Shenzhen, Guangdong (CN)

(21) Appl. No.: 15/510,696

(22) PCT Filed: Sep. 29, 2015
(86) PCT No.: PCT/CN2015/091013

§ 371 Date: Aug. 3, 2017

(30) Foreign Application Priority Data
Oct. 16, 2014 (CN) 201410548705.7

(51) Int. Cl. G06F 21/60; G06F 9/445

(52) U.S. Cl. CPC G06F 21/602; G06F 8/61

(57) ABSTRACT

Method for controlling mobile hard disk through mobile device is disclosed, in which, control software installed on a computer is used to detect whether APP control software exists in the same IP address segment with the computer, if exists, control software sends a key confirmation signal to APP control software, which accordingly sends back a feedback signal; when the feedback signal is to use an intelligent mobile device as a key of the mobile hard disk, control software generates a key signal and sends it to APP control software and a hidden sector of the mobile hard disk to save it therein. Through the process, the intelligent mobile device installed with APP control software may be used as the key of the mobile hard disk, then while using which, the key is needed instead of a password, thus the unnecessary loss may be prevented from the oblivion of the password.

### TECHNICAL FIELD

A method for controlling a mobile hard disk through a mobile device is related.

### BACKGROUND

A mobile hard disk is a data storage device, and has become an indispensable tool in daily activities and works nowadays. To use the mobile hard disk safely, most people may set a password which needs to be remembered, and then they can use the mobile hard disk after inputting the password correctly.

However, if the user forgets the password, it will make the mobile hard disk unable to be accessed, and make the data in the mobile hard disk unable to be used, which may lead to some severe consequences. Meanwhile, when the mobile hard disk needs to be borrowed, it needs to tell the password to others, which causes inconvenience to the owner.

### SUMMARY

The object is to provide a method for controlling a mobile hard disk through a mobile device, so as to solve at least one aspect of the problems above.

According to one aspect of the invention, a method for controlling a mobile hard disk through a mobile device is provided, comprising the following steps:

S101: installing control software of the mobile hard disk on a computer;

S102: downloading and installing APP control software corresponding to the control software on the mobile device;

S103: connecting the mobile hard disk to the computer, and using the control software to detect a mobile device with the APP control software in an IP address segment same with the computer;

performing step S1041 when the APP control software is detected;

S1041: using the control software to send a key confirmation signal to the APP control software, and then performing step S105;

when the APP control software is not detected, performing step S1042;

S1042: continuously using the control software to detect whether the APP control software exists in the IP address segment same with the computer;

S105: using the APP control software to send a feedback signal to the control software after the APP control software receives the key confirmation signal;

performing step S1061 when the mobile device is selected as the key of a mobile hard disk;

S1061: using the control software to generate a key signal according to the feedback signal, and then performing step S107;

performing step S1062 when the mobile device is not selected as the key of the mobile hard disk;

S1062: the control software performs no subsequent operation hereafter; and

S107: using the control software to send the key signal to the APP control software and a hidden sector of the mobile hard disk respectively to save it therein.

According to the present invention, the control software installed on the computer is used to detect whether a mobile device with the APP control software exists in an IP address segment same with the computer, when the APP control software is detected, a key confirmation signal is sent to the APP control software by the control software, and then the feedback signal is sent back to the control software by the APP control software; when the mobile device is determined to be used as the key of the mobile hard disk, a key signal is generated by the control software, and sent to the APP control software and the hidden sector of the mobile hard disk to save it therein. Through the process above, a mobile device installed with the APP control software is used as the key of the mobile hard disk, and then the key is needed to open the mobile hard disk while using the mobile hard disk, thus it is not necessary to remember the password, and the unnecessary loss may not be caused by forgetting the password.

In some embodiments, the method further comprises the steps of using the mobile device to decrypt:

S108: shifting out the mobile hard disk from the computer and then reconnecting the mobile hard disk to the computer;

S109: the control software detects whether the APP control software exists in the IP address segment same with the computer;

when the APP control software is detected, performing step S1101;

S1101; the control software detects the key signal sent by the APP control software and the key signal saved in the hidden sector of the mobile hard disk, and then step S111 is performed;

when the APP control software is not detected, performing step S1102;

S1102: the control software continuously detects whether the APP control software exists in the IP address segment same with the computer;

S111: when the key signal sent by the APP control software is consistent with the key signal saved in the hidden sector of the mobile hard disk, the control software decrypts the mobile hard disk; and

S112: when the key signal sent by the APP control software is not consistent with the key signal of the hidden sector of the mobile hard disk, the control software performs no subsequent operation.

In this way, the mobile hard disk may be decrypted through the steps above, and when the key signal of the APP control software is inconsistent with the key signal saved in the hidden sector of the mobile hard disk, the control software cannot decrypt the mobile hard disk, so that the mobile hard disk cannot be accessed, which results in the effect of confidentiality. Meanwhile, when the encrypted mobile hard disk is needed to be used, the mobile hard disk may be accessed and the data stored in the mobile hard disk may be read without needing to remember the password, as long as the mobile device installed with the APP control software exists and the mobile device has already been set as the key of the mobile hard disk.

In some embodiments, the method further comprises steps for backup and restoration after the steps of using the mobile device to decrypt:

S113: setting and saving the backup catalogue information of the mobile device through the APP control software after the control software decrypts the mobile hard disk via step S111;

S114: The APP control software sends a backup information signal to the control software; and

S115: The control software generates a backup signal according to the backup catalogue information signal and controls the mobile hard disk to perform backup.

In this way, catalogues in the mobile device for backup may be selected through step S113; and certainly, the date for backup may also be selected through the APP control software, or automatic check for updating and backup are performed during connection in each time.

In some embodiments, the method further comprises restoration steps:

S116: the control software detects the information backed up through the mobile hard disk; and

S117: The control software generates a restoration signal according to the information backed up and sends the restoration signal to the APP control software, by which the restoration is performed.

In this way, the information backed up may be restored to the APP control software through the restoration steps. That is, the information backed up may be restored to the mobile device.

### BRIEF DESCRIPTION OF THE DRAWINGS

FIG. 1 is a schematic diagram of a method for controlling a mobile hard disk through a mobile device according to an embodiment of the present invention;

FIG. 2 is a flow chart of the method for controlling a mobile hard disk through a mobile device shown in FIG. 1;

FIG. 3 is a flow chart of decrypting through the mobile device in the method for controlling a mobile hard disk through a mobile device shown in FIG. 1;

FIG. 4 is a flow chart of backup in the method for controlling a mobile hard disk through a mobile device shown in FIG. 1; and

FIG. 5 is a flow chart of restoration in the method for controlling a mobile hard disk through a mobile device shown in FIG. 1.

### DETAILED DESCRIPTION

The present invention is further described hereafter with reference to the drawings.

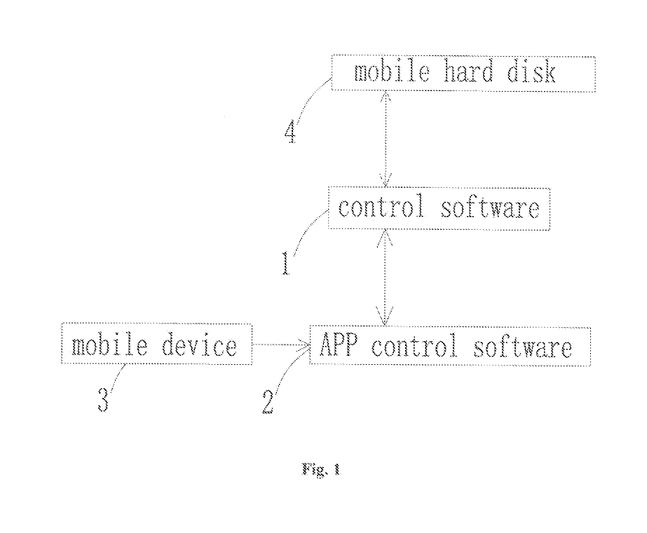

FIG. 1 schematically shows the principle of a method for controlling a mobile hard disk through a mobile device according to one embodiment of the present invention.

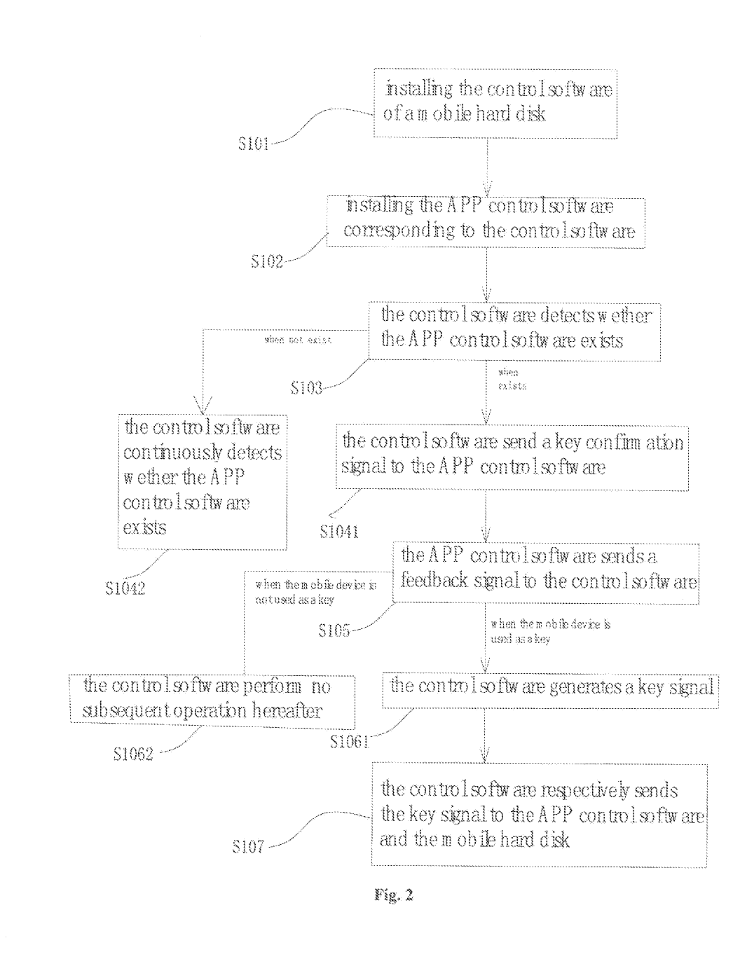

FIG. 2 to FIG. 4 schematically show the flow of a method for controlling a mobile hard disk through a mobile device according to one embodiment of the present invention.

As shown in FIG. 1 and FIG. 2, the principle and flow of the method for controlling a mobile hard disk through a mobile device are as follows.

In S101, a user installs a control software 1, which can decrypt an encrypted mobile hard disk 4 and access it, on a computer.

In S102, the user installs an APP control software 2 corresponding to the control software 1 on a mobile device, and the APP control software 2 can be downloaded in advance.

The mobile device may be a smart phone, a tablet personal computer, or the like.

The APP control software 2 may perform data transmission with the control software 1, and both the APP control software 2 and the control software 1 are programs configured in advance.

In S103, the mobile hard disk 4 is connected to the computer through a data interface (such as a USB data interface), and as they are connected, the control software 1 enables a detection program, and detects whether the APP control software 2 exists in the same IP address segment with the computer (being in the same IP address segment is to detect the mobile devices 3 in the same local area network with the computer only, instead of detecting other mobile devices). In this case, two conditions may occur.

Condition I: an APP control software 2 is detected in the same IP address segment with the computer by the control software 1, in this case, step S1041 is performed.

To detect whether the APP control software 2 exists is namely to detect whether a certain mobile device 3 is installed with the APP control software 2.

In S1041, the control software 1 sends a key confirmation signal to the APP control software 2, and then step S105 is performed.

Condition II: step S1042 is performed when the APP control software 2 is not detected.

In S1042, the control software 1 continuously detects whether the APP control software 2 exists in the same IP address segment (i.e. the same local area network) with the computer.

In the foregoing step S1042, the control software 1 will repeat the detection all the time when the APP control software 2 is not detected.

In S105, the APP control software 2 may display the key confirmation signal through a display screen of the mobile device 3 when a key confirmation signal is received, for example, the information may be displayed as “whether to use the mobile device as the key”, “yes” and “no”, or the like. And the user can operate the mobile device 3 according to the requirement thereof, to control the APP control software 2 to send a feedback signal to the control software 1.

Certainly, the information displayed by the mobile device may also be information similar to “whether to use the mobile device as the key”, such as “being used as the key or not”, etc., as long as the user can operate the mobile device to independently select whether to use the mobile device as the key of the mobile hard disk, the information displayed will be accepted.

If the user selects the mobile device 3 as the key of the mobile hard disk 4 (i.e., selecting “yes”), step S1061 will then be performed.

In S1061, the control software 1 generates a key signal according to the feedback signal, and then step S107 is performed.

If the mobile device 3 is not selected as the key of the mobile hard disk 4 (i.e., selecting “no”), then step S1062 will be performed.

In S1062, the control software 1 does not perform a subsequent operation hereafter.

In S107, the control software 1 respectively sends the key signal to the APP control software 2 and a hidden sector of the mobile hard disk 4, so that the signal can be saved therein when “yes” is selected.

The mobile hard disk 4 may be decrypted using the key signal saved in the APP control software 2 and the key signal saved in the mobile hard disk 4.

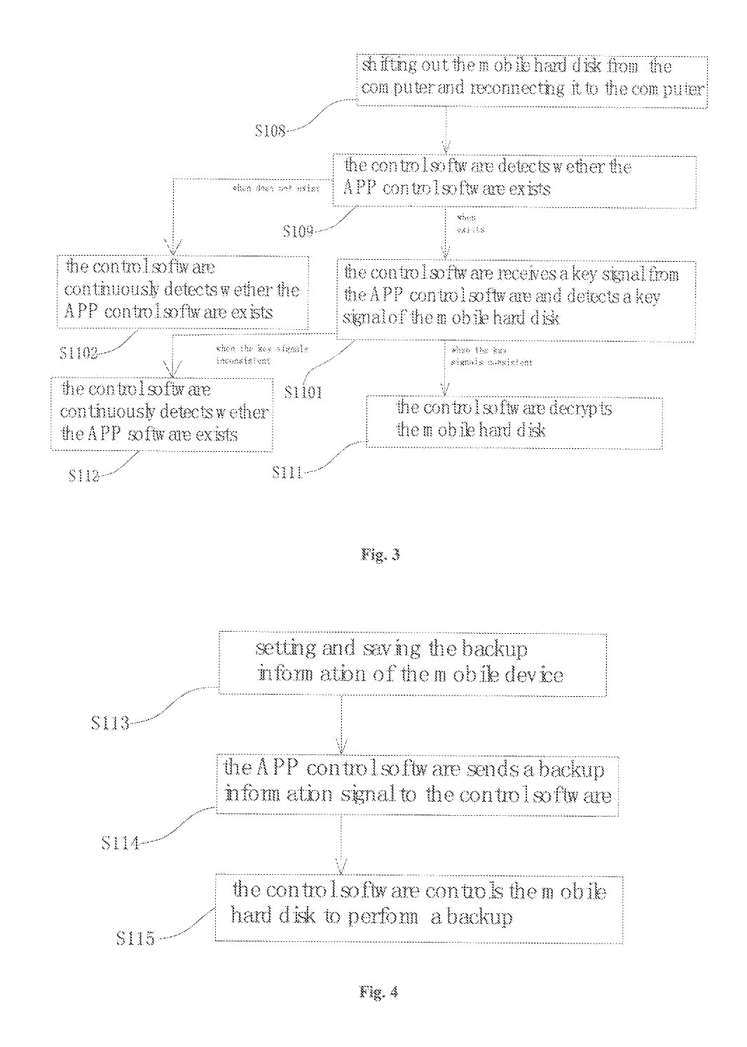

As shown in FIG. 3, the flow of using the mobile device 3 to decrypt the mobile hard disk 4 is as follows.

In S108, the mobile hard disk 4 is shifted out from the computer and then is reconnected to the computer.

Step S108 is necessary if the mobile hard disk 4 is set with the key for the first time, for the control software 1 cannot enable a subsequent step S109 if step S108 is not performed, which is to say, the control software 1 may not detect whether the APP control software 2 exists in the same IP address segment with the computer. If the mobile hard disk 4 is not set with the key for the first time (which means the mobile hard disk has already been set with a key before it is connected to the computer), step S108 can be unnecessary.

In S109, the control software 1 detects whether the APP control software 2 exists in the same IP address segment with the computer.

Because the mobile device 3 is already set as the key in step S107 above, step S1041 or step S1042 may not be performed here.

In S1101, the control software 1 detects the key signal of the APP control software 2 and the key signal of the hidden sector of the mobile hard disk 4, and step S111 is then performed.

In step S1101, it is possible that there is no key saved in the APP control software 2 itself, and in this case, the key signal of the APP control software 2 detected by the control soft ware 1 will be certainly different with the key signal of the hidden sector of the mobile hard disk 4.

Step S1102 is performed when the APP control software 2 is not detected.

In S1102, the control software 1 continuously detects whether the APP control software 2 exists in the same IP address segment with the computer.

In S111, the control software 1 decrypts the mobile hard disk 4 if the key signal of the APP control software 2 is consistent with the key signal of the hidden sector of the mobile hard disk 4.

In S112, the control software 1 does not perform a subsequent operation if the key signal sent by the APP control software 2 is not consistent with the key signal of the hidden sector of the mobile hard disk 4. That is to say, the control software 1 will not decrypt the mobile hard disk 4.

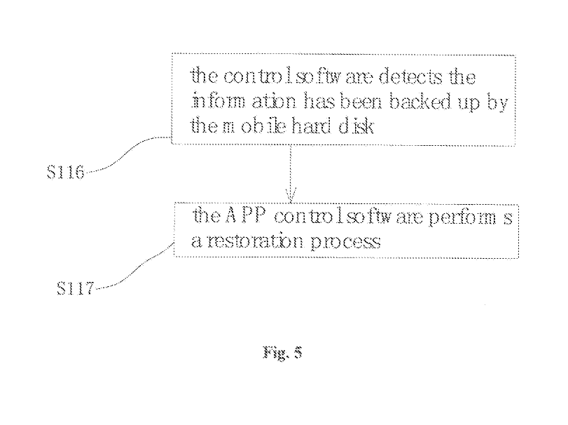

As shown in FIG. 4, a backup flow is as follows.

In S113, the backup catalogue information of the mobile device 3 is set via the APP control software 2 (that is to say, an item to be backed up is selected through the APP control software 2) and saved after the control software 1 decrypts the mobile hard disk 4 by performing step S111.

In S114, the APP control software 2 sends a backup catalogue information signal to the control software 1.

In S115, the control software 1 generates a control signal according to the backup catalogue signal to control the mobile hard disk 4 to perform a backup.

In step S113, the catalogue necessary in the mobile device 3 may be selected and backed up, or the backup may also be performed according to the date, or automatic check for updating and backup may be performed during connection in each time.

During the automatic check for updating and backup, the control software 1 compares the information backed up by the mobile device 3 with the backup catalogue information of the APP control software 2, and when the backup catalogue information is consistent with the information backed up by the mobile device 3, the backup is not performed; otherwise, the backup is performed.

As shown in FIG. 5, a restoration flow is as follows.

In S116, the control software 1 detects the information backed up through the mobile hard disk 4.

In S117, the control software 1 generates a restoration signal according to the information backed up and sends the restoration signal to the APP control software 2, and then a restoration is performed by the APP control software 2.

Certainly, the information backed up may be saved in the control software 1, and when some information, which has been backed up, in the mobile device 3 is lost, the mobile device 3 may be connected to the computer through step S116, and the information backed up will be restored to the mobile device 3 through the control software 1. During restoration, the control software 1 detects the information backed up by the mobile hard disk 4, and generates restoration information according to the information backed up to perform an restoration operation to the APP control software 2. For example, when address information in the mobile device 3 is lost, the control software 1 may send the restoration information of the address backed up by the mobile hard disk 4 to the APP control software 2, and the APP control software 2 saves the address information, so that the restoration is finished.

The contents above are only some embodiments of the present invention. Those skilled in the art may also make a plurality of deformations and improvements without departing from the conception of the present invention, which shall all fall within the protection scope of the present invention.

1. A method for controlling a mobile hard disk through a mobile device, comprising the following steps:
S101: installing control software (1) on a computer;
S102: installing APP control software (2) corresponding to the control software (1) on an intelligent mobile device (3);
S103: the control software (1) detects whether the APP control software (2) exists in an IP address segment same with the computer;
performing step S1041 if the APP control software (2) installed is detected;
S1041: the control software (1) sends a key confirmation signal to the APP control software (2), and then step S105 is performed;
performing step S1042 if there is no APP control software (2) detected;
S1042: the control software (1) continuously detects whether the mobile device in an IP address segment same with the computer is configured with the APP control software (2);
S105: when the key confirmation signal is received, the APP control software (2) sends a feedback signal to the control software (1);
performing step S1061 when the intelligent mobile device (3) is selected as the key of a mobile hard disk (4);
S1061: the control software (1) generates a key signal according to the feedback signal, and then step S107 is performed:
performing step S1062 when the mobile device (3) is not selected as the key of the mobile hard disk (4);
S1062: the control software (1) performs no subsequent operation hereafter; and
S107: the control software (1) respectively sends the key signal to the APP control software (2) and a hidden sector of the mobile hard disk (4) to save the signal therein.

2. The method for controlling a mobile hard disk through a mobile device according to claim 1, further comprising the steps of using the intelligent mobile device (3) to decrypt:
S108: shifting out the mobile hard disk (4) from the computer and then reconnecting the mobile hard disk (4) to the computer;
S109: the control software (1) detects whether the APP control software (2) exists in an IP address segment same with the computer;
performing step S1101 if the APP control software (2) is detected;
S1101: the control software (1) detects the key signal sent by the APP control software (2) and the key signal of the hidden sector of the mobile hard disk (4), and then step S111 is performed;
performing step S1102 if the APP control software (2) is not detected;
S1102: the control software (1) continuously detects whether the APP control software (2) exists in an IP address segment same with the computer;
S111: the control software (1) decrypts the mobile hard disk (4) when the key signal sent by the APP control software (2) is consistent with the key signal sent by the hidden sector of the mobile hard disk (4); and
S112: the control software (1) performs no subsequent operation when the key signal sent by the APP control software (2) is not consistent with the key signal of the hidden sector of the mobile hard disk (4).

3. The method for controlling a mobile hard disk through a mobile device according to claim 2, further comprising backup steps:
S113: setting the backup catalogue information of the mobile device (3) through the APP control software (2) and saving the backup catalogue information in the APP control software (2) after the control software (1) decrypts the mobile hard disk (4) by performing the step S111;
S114: the APP control software (2) sends a backup catalogue information signal to the control software (1); and
S115: the control software (1) generates a backup signal according to the backup catalogue information signal to control the mobile hard disk (4) to perform backup.

4. The method for controlling a mobile hard disk through a mobile device according to claim 3, further comprising restoration steps:
S116: the control software (1) detects the information having been backed up by the mobile hard disk (4); and
S117: the control software (1) generates a restoration signal according to the information backed up and sends it to the APP control software (2), and then the APP control software (2) performs the restoration.

5. A method for controlling a mobile hard disk through a mobile device, comprising
a control software (1) of a mobile hard disk detects whether a mobile device pre-installed with an APP control software (2) corresponding to the control software exists in the same IP address segment repeatedly, and when the mobile device pre-installed with the APP control software is detected, the mobile device (3) performs data transmission with the control software (1) through the APP control software (2) to execute corresponding operations to the mobile hard disk (4).

6. The method according to claim 5, wherein the corresponding operations comprise:
performing a key binding process to use the mobile device (3) as the key of the mobile hard disk (4);
wherein the key binding process comprises:
using the control software (1) to send a key confirmation signal to the APP control software (2);
using the APP control software (2) to receive the key confirmation signal and to send a feedback signal to the control software (1); and
using the control software (1) to perform a determine that whether the mobile device (3) is selected as the key of the mobile hard disk (4) according to the feedback signal, and generate a key signal when the feedback signal is that the mobile device (3) is selected as the key of the mobile hard disk (4), and respectively send the key signal to the APP control software (2) and a hidden sector of the mobile hard disk (4) to save the signal therein.

7. The method according to claim 6, wherein the corresponding operations further comprise:
using the mobile device to decrypt the mobile hard disk;
wherein a decryption process comprises:
using the control software (1) to receive the key signal sent by the APP control software (2) and detect the key signal of the hidden sector of the mobile hard disk (4), and match the two key signals, and then decrypt the mobile hard disk (4) when the key signal sent by the APP control software (2) is consistent with the key signal saved in the hidden sector of the mobile hard disk.

8. The method according to any one of claims 5 to 7, wherein the corresponding operations further comprise:
the mobile device performs data transmission of backup information with the control software (1) using the APP control software (2) when the mobile hard disk is decrypted, and the control software performs a backup process on the mobile hard disk according to a backup signal.

9. The method according to claim 8, wherein the backup process comprises:
using the APP control software (2) to set the backup catalogue information of the mobile device (3), saving the backup catalogue information in the APP control software (2);
using the APP control software (2) to send a backup catalogue information signal to the control software (1) according to given backup catalogue information of the mobile device; and
using the control software (1) to generate the backup signal according to the backup catalogue information signal, and using the control software (1) to control the mobile hard disk (4) to perform the backup.

10. The method according to claim 9, wherein the corresponding operations further comprise:
using the control software (1) to receive a data restoration request from the APP control software (2) when the mobile hard disk is decrypted, and detect information backed up by the mobile hard disk (4), and generate a restoration signal according to the information backed up, and then send the restoration signal to the APP control software (2); then using the APP control software (2) to perform the data restoration through the information backed up according to the restoration signal.
